(19) United States
(12) Patent Application Publication
(10) Pub. No.: US 2025/0222614 A1
(43) Pub. Date: Jul. 10, 2025

(54) SLICING MACHINE AND METHOD FOR SLICING FOODS

(71) Applicant: MULTIVAC SEPP HAGGENMÜLLER SE & CO. KG, Wolfertschwenden (DE)

(72) Inventor: Albert HARTMANN, Dietmannsried (DE)

(73) Assignee: MULTIVAC SEPP HAGGENMÜLLER SE & CO. KG, Wolfertschwenden (DE)

(21) Appl. No.: 19/010,404

(22) Filed: Jan. 6, 2025

(30) Foreign Application Priority Data
Jan. 8, 2024 (DE) 102024100341.3

(51) Int. Cl. B26D 7/06; B26D 1/28

(52) U.S. Cl. CPC B26D 7/0683; B26D 1/28; B26D 2210/02

(57) ABSTRACT

A slicing machine for slicing foods comprises a feed unit adapted to feed a product caliber along a feed direction and a cutting unit adapted to cut the product caliber into slices. The cutting unit comprises a blade and the cutting unit is configured to perform a run-out movement in order to make one or more blank cuts, during which the blade is moved along a direction substantially parallel to an axis of rotation of the blade from a slicing position to a blank cutting position in which, during a respective rotation of the blade about the axis of rotation, no slice is cut off from the product caliber. The feed unit is adapted, while the one or more blank cuts are being made, to move the product caliber away from the cutting unit against the feed direction.

### CROSS-REFERENCE TO RELATED APPLICATIONS

This application claims foreign priority benefits under 35 U.S.C. § 119 (a)-(d) to German patent application number DE 102024100341.3, filed Jan. 8, 2024, which is incorporated by reference in its entirety.

### TECHNICAL FIELD

The disclosure relates to a slicing machine, in particular a slicer, for slicing foods, comprising a feed unit which is adapted to feed at least one product caliber along a feed direction and a cutting unit which is adapted to cut the at least one product caliber into slices, wherein the cutting unit comprises a blade which can be rotatingly driven about an axis of rotation and wherein the cutting unit is configured and adapted to perform a run-out movement in order to make one or more blank cuts during which the blade is moved along a direction substantially parallel to the axis of rotation of the blade from a slicing position adapted for cutting the at least one product caliber into slices to a blank cutting position in which, during a respective rotation of the blade about the axis of rotation, no slice is cut off from the at least one product caliber.

Already at this point it should be noted that the slicing machine according to the disclosure is intended for cutting food, in particular in the form of so-called product calibers, into slices from which preferably shingled or stacked portions can be formed. The product calibers can, for example, consist of sausage, cheese, waxed meat, pressed meat and the like. The feed unit can, for example, be configured as an endlessly circulating conveyor belt or similar. With regard to the feed direction, the cutting unit is preferably arranged downstream of the feed unit. By means of the blade, which is mounted on the cutting unit, the slices can be cut off from an end of a respective product caliber facing the cutting unit.

Furthermore, the product calibers are usually fed towards the blade of the cutting unit by means of a downwardly inclined feed conveyor of the feed unit, so that the slices are already inclined at an angle to the vertical when they are cut off and can easily fall onto a discharge conveyor of a discharge unit of the slicing machine, by which means the slices can be discharged for further processing. Consequently, the blade is also usually arranged with its cutting plane at an angle and leaning forwards in the feed direction.

All of the above also applies to the slicing machine according to the disclosure.

### BACKGROUND

As a rule, product calibers are cut into portions, each of which can consist of several slices, by means of a slicing machine having a cutting unit with a blade. After a portion has been completely sliced, one or more blank cuts are usually made in order to allow a discharge conveyor of a discharge unit sufficient time to discharge the finished portion along a discharge direction.

A blank cut is defined as one in which, during a respective rotation of the blade about the axis of rotation, no slice is cut from the at least one product caliber. This can be enabled by an arrangement whereby the cutting unit performs a run-out movement to a blank cutting position, in which, during a respective rotation of the blade about the axis of rotation, no slice is cut off from the at least one product caliber.

After a desired number of blank cuts have been made, the blade must be moved back in the direction substantially parallel to the axis of rotation of the blade, from the blank cutting position to a slicing position, corresponding to a run-in movement of the blade. In known slicing machines, the run-out movement and run-in movement must be performed relatively quickly, as otherwise so-called shredding can occur, in which misshapen or unusable slices or partial slices are cut off from the product caliber. Since, as mentioned above, the blade is usually arranged with its cutting plane at an angle to the vertical and leaning forwards in the feed direction, depending on the angle of inclination of the cutting plane, the gravitational force acting on the cutting unit, in particular on the blade, must also be at least partially overcome during the run-in movement. This can lead to high stresses and thus to heavy wear on the cutting unit's run-out drive unit which is adapted to perform the run-out movement and the run-in movement.

### SUMMARY

It is therefore a task of the disclosure to remedy this situation, in particular by providing a slicing machine which is able to minimize the risk of shredding while blank cuts are being made and which requires as little maintenance as possible.

According to the disclosure, this task is solved by a slicing machine of the type mentioned at the outset in which the feed unit is furthermore adapted to move the at least one product caliber away from the cutting unit, in particular from a cutting plane of the blade, in order to perform a retraction movement against the feed direction while the one or more blank cuts are being made, the cutting unit and the feed unit being configured and adapted to be operated in such a way, when making the one or more blank cuts, that a run-in movement of the blade from the blank cutting position to the slicing position and the retraction movement of the product caliber against the feed direction at least partially overlap in time.

Since, according to the disclosure, the run-in movement of the blade from the blank cutting position to the slicing position and the retraction movement of the product caliber against the feed direction away from the cutting unit at least partially overlap in time, i.e. are performed at least partially in parallel in time, more time is allowed for the run-in movement of the blade, which is particularly gentle on the cutting unit, in particular the run-out drive unit of the cutting unit. In other words, the run-in movement of the blade is started as early as possible so as to be able to perform the run-in movement, which can usually take place against the force of gravity, as gently, i.e. as slowly, as possible. Preferably, the blade is moved substantially in the feed direction when performing the run-out movement and/or is moved substantially in the opposite direction to the feed direction when performing the run-in movement.

The mode of operation of the slicing machine according to the disclosure when making the one or more blank cuts can be as follows:

First, the cutting unit can perform the run-out movement, during which the blade is moved in the direction substantially parallel to the axis of rotation of the blade, preferably as quickly as possible, from the slicing position to the blank cutting position.

The cutting unit and the feed unit can then be operated in such a way that the blade performs the run-in movement from the blank cutting position to the slicing position, and the feed unit performs the retraction movement of the product caliber against the feed direction at least partially overlapping in time with the run-in movement of the blade. The run-in movement and the retraction movement can therefore be performed at least partially in parallel or simultaneously. The run-in movement and the retraction movement can be performed at a lower speed than the above-mentioned run-out movement.

After a desired number of blank cuts have been made, the feed unit can move the product caliber in the feed direction to the cutting unit by means of a feed movement, preferably also as quickly as possible, in order to cut further slices from the at least one product caliber.

To be particularly gentle on the run-out drive unit, especially with a blade arranged at an angle to the vertical, it is proposed according to one exemplary embodiment that the cutting unit is adapted to perform the run-out movement with an acceleration and/or a speed in the feed direction which is/are higher than an acceleration and/or a speed of the run-in movement against the feed direction. The rapid run-out movement also reliably prevents the above-mentioned shredding.

Additionally or alternatively, the feed unit can be configured to move the at least one product caliber, after the one or more blank cuts have been made, to the cutting unit to perform a feed movement with an acceleration and/or a speed in the feed direction which is/are higher than an acceleration and/or a speed of the retraction movement against the feed direction. This means that drive units of the feed unit can also be treated particularly gently, especially if the feed unit is arranged at an angle. This can also reduce the tendency of the product caliber to swing up or swing over during the retraction movement, as the retraction movement can be performed as slowly as possible.

According to a further exemplary embodiment, while the one or more blank cuts are being made, the feed unit can be configured to move the product caliber away from the cutting unit against the feed direction only when the cutting unit has at least partially performed the run-out movement of the blade. This means that, even if the product caliber is loosened, for example if the product caliber is curved or deformed in the feed direction, shredding does not occur, as the blade is already far enough away from the product caliber when the product caliber begins to move against the feed direction. The retraction movement is therefore preferably only started when the blade has at least partially performed the run-out movement, which can correspond, for example, to a predefined stroke movement of the blade in the feed direction.

The cutting unit can also be configured, while the one or more blank cuts are being made, to initiate the run-in movement of the blade from the blank cutting position to the slicing position only after the feed unit has started to move the at least one product caliber away from the cutting unit against the feed direction. The run-in movement can therefore preferably only be started once the product caliber has been moved away from the cutting unit against the feed direction in order to avoid shredding.

Additionally or alternatively, to prevent shredding when the product caliber is loosened, the run-out movement and/or the run-in movement of the cutting unit can have a stroke in the feed direction in a range from 0.5 mm to 15 mm, preferably from 1 mm to 8 mm. Since only the run-out movement, preferably with a directional component parallel to the direction of gravity, is performed at high speed and/or acceleration, a suitably large stroke can be chosen.

Furthermore, the retraction movement and/or the feed movement of the feed unit can preferably have a stroke in and/or against the feed direction in a range from 0.5 mm to 15 mm, preferably from 1 mm to 8 mm. In a manner analogous to the last-mentioned exemplary embodiment, the retraction movement and/or the feed movement can also have a comparatively large stroke.

For even better control of the movement of the product caliber through the feed unit, it is proposed that the slicing machine further comprises a gripper unit with at least one gripper which is adapted to grip the at least one product caliber at its end facing away from the cutting unit.

Furthermore, the slicing machine may comprise, in a manner known per se, a portioning unit which is adapted to form portions from the slices cut by the cutting unit, with each portion comprising one or more slices.

It should also be added that the slicing machine may additionally or alternatively comprise a discharge unit which is adapted to discharge the slices cut by the cutting unit along a discharge direction in order to be able to further process and/or package the cut slices and/or portions.

According to a further aspect, the disclosure relates to a method for slicing foods by means of a slicing machine, in particular a slicing machine according to the disclosure as described above, comprising the following steps:
Feeding, by means of a feed unit of the slicing machine, at least one product caliber along a feed direction, and
Slicing, by means of a cutting unit of the slicing machine, the at least one product caliber into slices, with a blade of the cutting unit being rotatingly driven about an axis of rotation, and
By means of the cutting unit, performing a run-out movement in order to make one or more blank cuts, the blade being moved along a direction substantially parallel to the axis of rotation of the blade from a slicing position, which is adapted to cut the at least one product caliber into slices, to a blank cutting position in which, during a respective rotation of the blade about the axis of rotation, no slice is cut off from the at least one product caliber,
While the one or more blank cuts are being made, the at least one product caliber being moved away from the cutting unit, in particular from a cutting plane of the blade, in order to perform a retraction movement against the feed direction,
While the one or more blank cuts are being made, the cutting unit and the feed unit being operated in such a way that a run-in movement of the blade from the blank cutting position to the slicing position and the retraction movement of the at least one product caliber against the feed direction at least partially overlap in time.

With regard to the advantages and effects of the method according to the disclosure, reference is made already at this point to the advantages and effects of the slicing machine according to the disclosure. All statements regarding the slicing machine according to the disclosure also apply to the method according to the disclosure and vice versa.

Preferably, the cutting unit can perform the run-out movement with an acceleration and/or a speed in the feed direction which is/are higher than an acceleration and/or a speed of the run-in movement against the feed direction.

Additionally or alternatively, the feed unit can move the at least one product caliber, after the one or more blank cuts have been made, to the cutting unit to perform a feed movement with an acceleration and/or a speed in the feed direction which is/are higher than an acceleration and/or a speed of the retraction movement against the feed direction.

According to an exemplary embodiment, while one or more blank cuts are being made, the feed unit can move the product caliber away from the cutting unit against the feed direction only when the cutting unit has at least partially performed the run-out movement of the blade.

Finally, while the one or more blank cuts are being made, the cutting unit can initiate the run-in movement of the blade from the blank cutting position to the slicing position only after the cutting unit has started to move the product caliber away from the cutting unit against the feed direction.

### BRIEF DESCRIPTION OF THE DRAWINGS

The disclosure will be explained in more detail below with reference to the attached drawings on the basis of an exemplary embodiment. The following are shown:

FIG. 1a: A perspective view of an exemplary embodiment of a slicing machine according to the disclosure;

FIG. 1b: A side view of the slicing machine shown in FIG. 1a; and

FIGS. 2a to 2d: Schematic side views of components of the slicing machine in different operating positions in order to explain the functioning of the slicing machine according to the disclosure.

### DETAILED DESCRIPTION

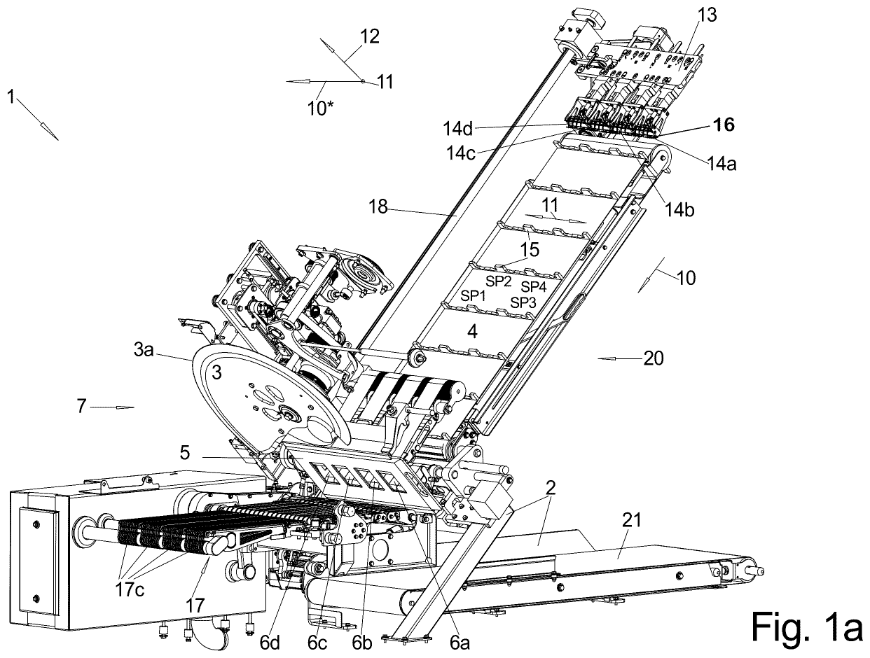

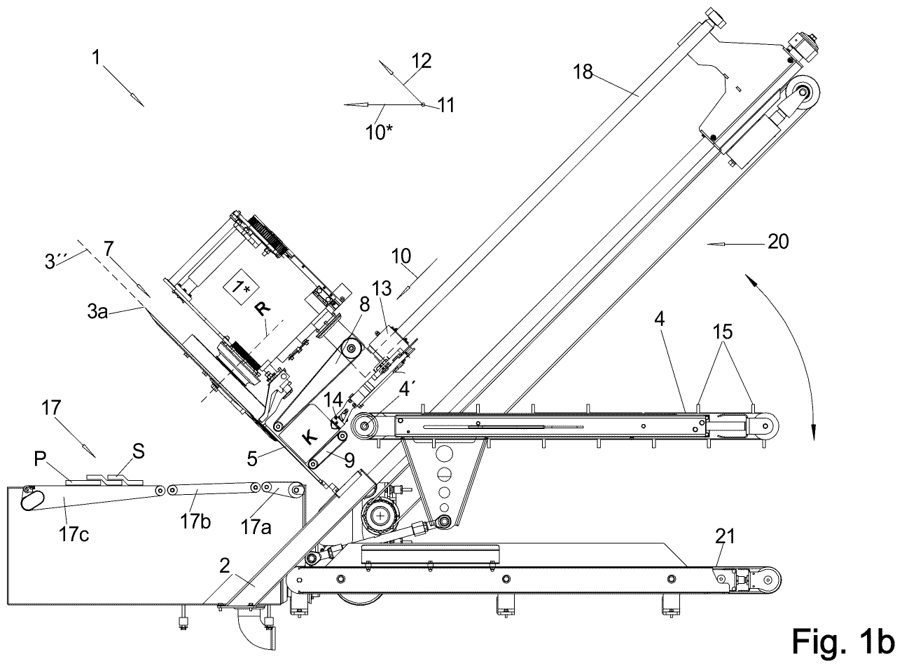

FIGS. 1a and 1b show a slicing machine 1 in the form of a multi-track slicer 1 for the simultaneous slicing of multiple product calibers K, each on one track SP1 to SP4 lying adjacent to one another, and depositing them in shingled portions P each consisting of multiple slices S, with a general throughput direction 10* through the slicer 1 from right to left.

FIG. 1b shows—with product caliber K inserted—a side view of the slicer 1, omitting covers and other parts that are attached to a base frame 2, so that the functional parts, especially the conveyor belts, are more clearly visible. The longitudinal direction 10 is the feed direction of the product caliber K to a cutting unit 7 and thus also the longitudinal direction of the product caliber K lying in the slicer 1.

The cutting unit 7 of the slicer 1 with a blade 3 rotating about an axis of rotation R, for example a sickle blade 3, can be fed several, in this case four, product calibers K lying adjacent to one another transversely to the feed direction 10 on a feed conveyor 4 with projections 15 of the feed conveyor 4 protruding from a support surface as spacers between them, by a feed unit 20 from whose front ends the rotating blade 3 can cut off a slice S with its cutting edge 3a in a single operation.

For slicing the product caliber K, the feed conveyor 4 is in the inclined slicing position shown in FIG. 1a, with the cutting-side front end lying low and the rear end lying high, from which it can be lowered about a pivot axis 4′ running in its width direction, the first transverse direction 11, located close to the cutting unit 7, to an approximately horizontal loading position, as shown in FIG. 1b.

The rear end of each product caliber K lying in the feed unit 20 is held in a form-fitting manner by a gripper 14 or 14a-d with the aid of gripper claws 16. These grippers 14 or 14a-14d, which can be activated and deactivated with respect to the position of the gripper claws 16, are attached to a common gripper unit 13 which can be moved along a gripper guide 18 in the feed direction 10.

The feed of both the gripper unit 13 and the feed conveyor 4 can be driven in a controlled manner, but the actual feed speed of the product calibers K is determined by so-called upper and lower driven product guides 8, 9, also driven in a controlled manner, that engage the upper and lower sides of the product calibers K to be sliced in their front end regions close to the cutting unit 7.

The front ends of the product calibers K are each guided through a product opening 6a-d of a plate-type cutting frame 5, with the cutting plane 3″ in which the blade 3 rotates with its cutting edge 3a about the rotation axis R—and thus cuts off the end of the product calibers K projecting from the cutting frame 5 as a slice S—running immediately in front of the front, downwardly inclined end face of the cutting frame 5. The cutting plane 3″ runs orthogonally to the upper run of the feed conveyor 4 and/or is spanned by the two transverse directions 11, 12 to the feed direction 10. The inner circumference of the product openings 6a-d serves as a counter-edge of the cutting edge 3a of the blade 3.

Since both product guides 8, 9 can be driven in a controlled manner, in particular independently of each other and/or possibly separately for each track SP1 to SP4, these determine the—continuous or timed—feed speed of the product caliber K through the cutting frame 5.

The upper product guide 8 can be displaced in the second transverse direction 12, which runs orthogonally to the surface of the upper run of the feed conveyor 4, in order to adapt to a height of the product caliber K in this direction. Furthermore, at least one of the product guides 8, 9 can be configured to be pivotable about one of its pulleys in order to be able to change, to a limited extent, the direction of a guide belt of the product guide 8 and/or 9 in contact with the respective product caliber K.

The slices S standing obliquely in the space while they are being cut fall onto a conveyor unit 17 which starts below the cutting frame 5 and runs in the throughput direction 10* and which, in the exemplary embodiment shown, comprises a plurality of discharge conveyors 17a, 17b, 17c arranged one after the other in the throughput direction 10*, of which the first conveyor 17a in the throughput direction 10* can be configured as a weighing unit and in particular as a portioning unit, in particular in the form of a portioning belt.

The slices S can land on the discharge unit 17 individually and spaced apart from one another in the throughput direction 10* or, by appropriate control of the discharge conveyor 17a, —whose movement, like almost all moving parts, is controlled by a control unit 1* of the slicer 1—can form shingled or stacked portions P (see FIG. 1b). The portions P can be formed, for example, through stepwise forward movement of the discharge conveyor 17a, which in the present case serves as a portioning unit, in the throughput direction 10*.

Below the feed unit 20, in the illustrated exemplary embodiment, there is a substantially horizontal waste conveyor 21 which starts with its front end below the cutting frame 5 and immediately below or behind the discharge unit 17 and which can transport waste falling onto it away towards the rear with its upper run.

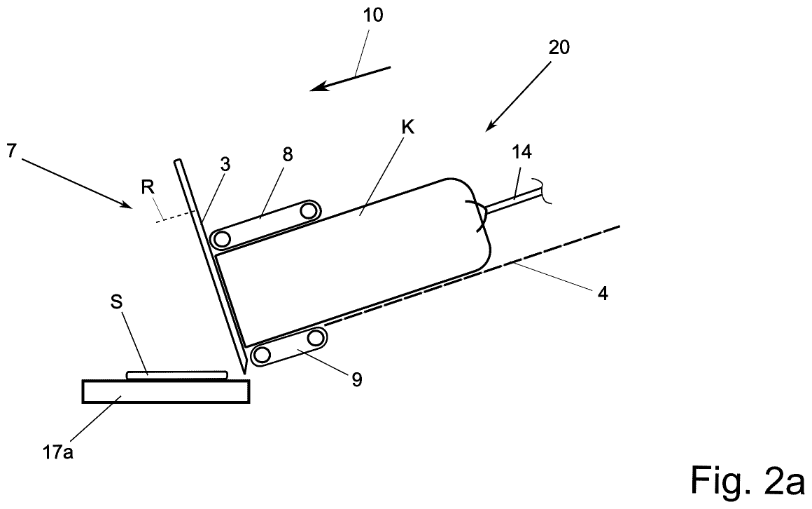

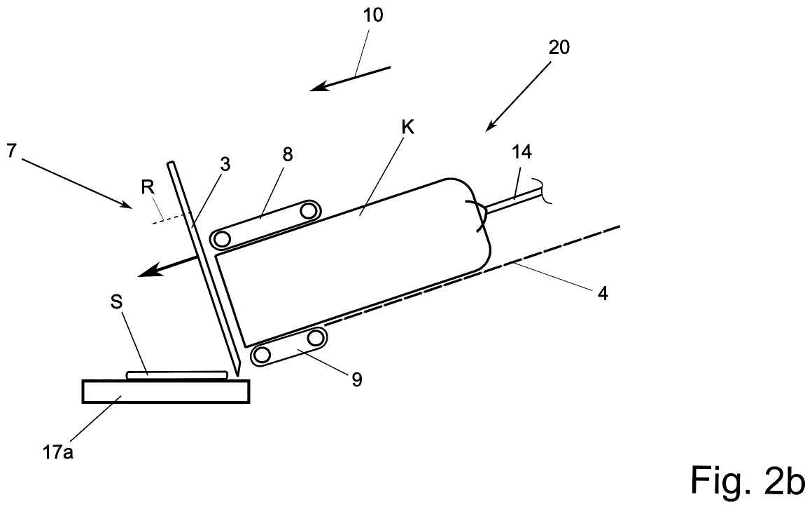

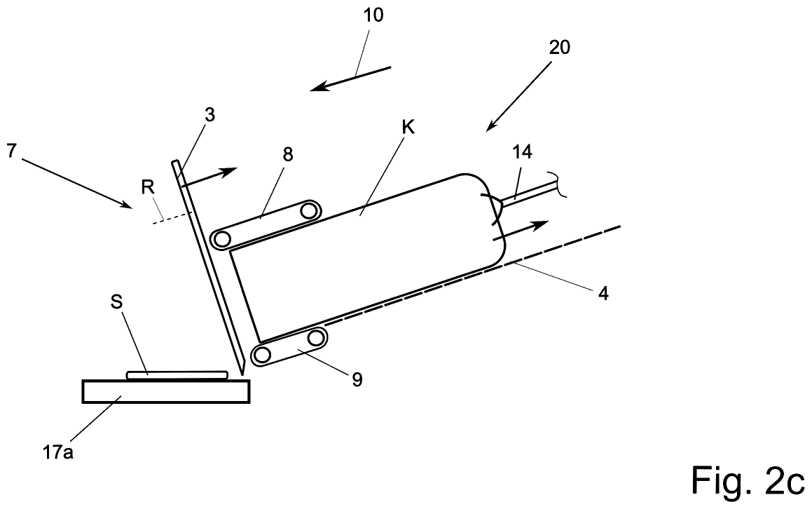

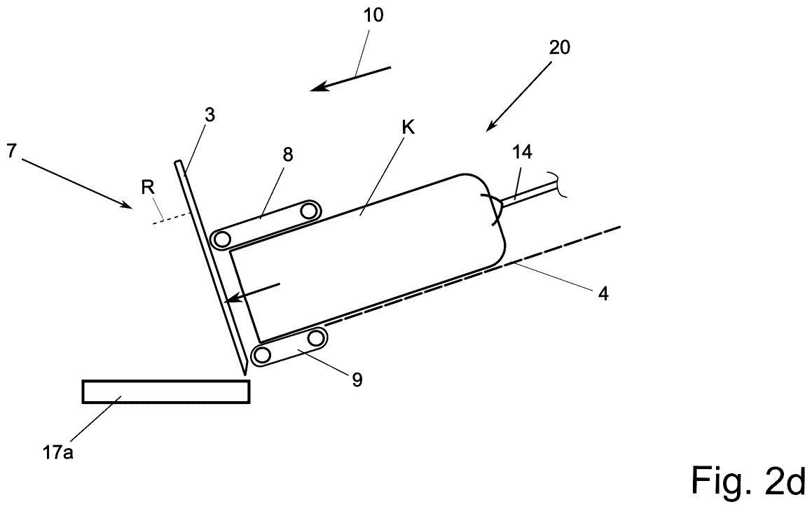

FIGS. 2a-2d are schematic side views of components of the slicing machine 1 in different operating positions in order to explain the functioning of the slicing machine 1 according to the disclosure.

The views shown in FIGS. 2a-2d are greatly simplified, showing the blade 3 of the cutting unit 7, which is rotatingly driven about an axis of rotation R, by which means the product caliber K can be cut into slices S which can fall down onto the discharge conveyor 17a. The product caliber K rests on a feed conveyor 4 of the feed unit 20, which is likewise only schematically illustrated, and is guided by an upper product guide 8 and a lower product guide 9. At its end facing away from the cutting unit 7, the product caliber K is furthermore held by a gripper 14, which is preferably movable in and against the feed direction 10. Furthermore, the product caliber K can preferably also be moved in and against the feed direction 10 by corresponding actuation of the feed unit 4, the lower product guide 9 and/or the upper product guide 8.

Moreover, it is expressly pointed out that, although the components shown in FIGS. 2a-2d are only shown schematically, they may also correspond in terms of their design to the components shown in FIGS. 1a and 1b, which are identified accordingly by analogous reference numbers.

In FIG. 2a, the blade 3 is in a slicing position, which is configured to slice the at least one product caliber K into slices S. FIG. 2a thus shows a normal slicing operation of the slicing machine 1, in which the product caliber K can be fed continuously or in a stepwise manner in the feed direction 10 in order to be sliced into one or more slices S.

Once a desired number of slices S have been cut, according to the disclosure the cutting unit 7 is adapted to perform a run-out movement to make one or more blank cuts whereby the blade 3 is moved along a direction essentially parallel to the axis of rotation R of the blade 3 from the slicing position shown in FIG. 2a to a blank cutting position shown in FIG. 2b, in which, during a respective rotation of the blade 3 about the axis of rotation R, no slice S is cut off from the at least one product caliber K. The movement of the blade 3 from the slicing position (FIG. 2a) to the blank cutting position (FIG. 2b) can take place at a comparatively high speed without causing an excessively high load on a run-out drive unit (not shown), such as an actuator (e.g., electric or pneumatic actuator), of the cutting unit 7, which is preferably adapted to move the blade 3 in and against the feed direction 10. This because the movement of the blade 3 in the feed direction 10 has a directional component that points at least partially in the direction of gravity, so that only a reduced force is required to move the blade 3 from the slicing position to the blank cutting position.

After the blade 3 has been transferred to the blank cutting position shown in FIG. 2b, according to the disclosure the cutting unit 7 and the feed unit 20 are operated as shown in FIG. 2c, so that the blade 3 performs a run-in movement against the feed direction 10 from the blank cutting position to the slicing position and at the same time the feed unit 20, for example the feed conveyor 4 and/or the upper product guide 8 and/or the lower product guide 9 and/or the gripper 14 perform a retraction movement of the product caliber K against the feed direction 10. Therefore, the run-in movement of the blade 3 is started as early as possible so as to be able to perform the run-in movement, which takes place at least partially against the force of gravity, as gently on the drive, i.e. as slowly, as possible. This also applies to the retraction movement of the product caliber K performed by the feed unit 20, as this can also be performed comparatively slowly, i.e. in a way that is gentle on the drive, without undesirable shredding due to contact between the blade 3 and the product caliber K, as the blade 3 is far enough away from the product caliber K in the feed direction 10 at the start of the retraction movement. Even if the product caliber K is moved in the opposite direction to the feed direction 10, the product caliber K may swing upwards if it is moved too quickly in the opposite direction to the feed direction 10, so that in an unfavorable case shredding may occur when the blade 3 is in the slicing position.

Once a desired number of blank cuts have been made, which can be the case, for example, when the discharge conveyor 17a has discharged one or more slices S located thereon, then, as shown in FIG. 2d, the feed unit 20 can move the product caliber K to the cutting unit 7 to perform a feed movement in the feed direction 10, i.e. to the blade 3, in order to start cutting slices S from the product caliber K once more. The feed movement in the feed direction 10 can take place with an acceleration and/or a speed in the feed direction 10 which is/are higher than an acceleration and/or a speed of the retraction movement explained above.

After the product caliber K has performed the feed movement, it preferably returns to the position shown in FIG. 2a. The cutting unit 7, in particular the blade 3, has then already reached its slicing position shown in FIG. 2a so as to be able to cut slices S from the product caliber K.

It should also be added that the cutting unit 7 can be configured to perform the run-out movement with an acceleration and/or a speed which is/are higher than an acceleration and/or a speed of the run-in movement.

The cutting unit 7 can also be configured, while the one or more blank cuts are being made, to initiate the run-in movement of the blade 3 from the blank cutting position to the slicing position only after the feed unit 20 has started to move the product caliber K away from the cutting unit 7 against the feed direction 10, thereby further reducing the risk of shredding.

Finally, it should also be mentioned that the strokes shown in FIGS. 2a-2d of the run-out movement and/or run-in movement of the cutting unit 7 and/or of the retraction movement and/or of the feed movement of the feed unit 20 may differ in magnitude from the strokes shown in FIGS. 2a-2d. Consequently, the strokes can also be smaller or larger in and/or against the feed direction 10, since the strokes shown in FIGS. 2a-2d are only intended to illustrate the mode of operation of the slicing machine 1.

As one skilled in the art would understand, the control unit 1*, run-out drive unit, as well as any other control, controller, unit, drive, system, subsystem, sensor, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC).

What is claimed is:

1. A slicing machine for slicing foods, comprising:
a feed unit which is adapted to feed at least one product caliber along a feed direction; and
a cutting unit which is adapted to cut the at least one product caliber into slices;
wherein the cutting unit comprises a blade which can be rotatingly driven about an axis of rotation, and the cutting unit is configured to perform a run-out movement in order to make one or more blank cuts during which the blade is moved along a direction substantially parallel to the axis of rotation of the blade from a slicing position adapted for cutting the at least one product caliber into slices to a blank cutting position in which, during a respective rotation of the blade about the axis of rotation, no slice is cut off from the at least one product caliber; and
wherein the feed unit is furthermore adapted to move the at least one product caliber away from the cutting unit in order to perform a retraction movement against the feed direction while the one or more blank cuts are being made, the cutting unit and the feed unit being configured to be operated in such a way, when making the one or more blank cuts, that a run-in movement of the blade from the blank cutting position to the slicing position and the retraction movement of the at least one product caliber against the feed direction at least partially overlap in time.

2. The slicing machine according to claim 1, wherein the feed unit is adapted to move the at least one product caliber away from a cutting plane of the blade during the retraction movement.

3. The slicing machine according to claim 1, wherein the cutting unit is adapted to perform the run-out movement with an acceleration and/or a speed in the feed direction which are/is higher than an acceleration and/or a speed of the run-in movement against the feed direction.

4. The slicing machine according to claim 1, wherein the feed unit is adapted to move the at least one product caliber, after the one or more blank cuts have been made, to the cutting unit to perform a feed movement with an acceleration and/or a speed in the feed direction which are/is higher than an acceleration and/or a speed of the retraction movement.

5. The slicing machine according to claim 1, wherein, while the one or more blank cuts are being made, the feed unit is configured to move the at least one product caliber away from the cutting unit against the feed direction only when the cutting unit has at least partially performed the run-out movement of the blade.

6. The slicing machine according to claim 1, wherein the cutting unit is configured, while the one or more blank cuts are being made, to initiate the run-in movement of the blade from the blank cutting position to the slicing position only after the feed unit has started to move the product caliber away from the cutting unit against the feed direction.

7. The slicing machine according to claim 1, wherein the run-out movement and/or the run-in movement of the cutting unit have/has a stroke in the feed direction in a range from 0.5 mm to 15 mm.

8. The slicing machine according to claim 1, wherein the run-out movement or the run-in movement of the cutting unit has a stroke in the feed direction in a range from 1 mm to 8 mm.

9. The slicing machine according to claim 1, wherein the retraction movement and/or a feed movement of the feed unit have/has a stroke in and/or against the feed direction in a range from 0.5 mm to 15 mm, preferably from 1 mm to 8 mm.

10. The slicing machine according to claim 1, wherein the retraction movement or a feed movement of the feed unit has a stroke in and/or against the feed direction in a range from 1 mm to 8 mm.

11. The slicing machine according to claim 1, wherein the slicing machine further comprises a gripper unit with at least one gripper which is adapted to grip the at least one product caliber at its end facing away from the cutting unit.

12. The slicing machine according to claim 1, wherein the slicing machine further comprises a portioning unit which is adapted to form portions from the slices cut by the cutting unit, with each portion comprising one or more slices.

13. The slicing machine according to claim 1, wherein the slicing machine further comprises a discharge unit which is adapted to discharge the slices cut by the cutting unit along a discharge direction.

14. A method for slicing foods by a slicing machine, comprising:
feeding, by a feed unit of the slicing machine, at least one product caliber along a feed direction;
slicing, by a cutting unit of the slicing machine, the at least one product caliber into slices, with a blade of the cutting unit being rotatingly driven about an axis of rotation; and
performing a run-out movement with the cutting unit in order to make one or more blank cuts, the blade being moved along a direction substantially parallel to the axis of rotation of the blade from a slicing position, which is adapted to cut the at least one product caliber into slices, to a blank cutting position in which, during a respective rotation of the blade about the axis of rotation, no slice is cut off from the at least one product caliber;
wherein, while the one or more blank cuts are being made, the at least one product caliber is moved away from the cutting unit, in order to perform a retraction movement against the feed direction, and while the one or more blank cuts are being made, the cutting unit and the feed unit are operated in such a way that a run-in movement of the blade from the blank cutting position to the slicing position and the retraction movement of the at least one product caliber against the feed direction at least partially overlap in time.

15. The method according to claim 14, wherein the at least one product caliber is moved away from a cutting plane of the blade during the retraction movement.

16. The method according to claim 14, wherein the cutting unit can perform the run-out movement with an acceleration and/or a speed in the feed direction which are/is higher than an acceleration and/or a speed of the run-in movement against the feed direction.

17. The method according to claim 14, wherein the feed unit can move the at least one product caliber, after the one or more blank cuts have been made, to the cutting unit to perform a feed movement with an acceleration and/or a speed in the feed direction which are/is higher than an acceleration and/or a speed of the retraction movement against the feed direction.

18. The method according to claim 14, wherein, while the one or more blank cuts are being made, the feed unit moves the product caliber away from the cutting unit against the feed direction only when the cutting unit has at least partially performed the run-out movement of the blade.

19. The method according to claim 14, wherein the cutting unit, while the one or more blank cuts are being made, initiates the run-in movement of the blade from the blank cutting position to the slicing position only after the feed unit has started to move the product caliber away from the cutting unit against the feed direction.
